(19) United States
(12) Patent Application Publication
(10) Pub. No.: US 2015/0113788 A1
(43) Pub. Date: Apr. 30, 2015

(54) VACUUM TIGHT THREADED JUNCTION

(71) Applicant: CONSORZIO RFX, Padova (IT)

(72) Inventors: Piero Agostinetti, Padova (IT); Mauro Dalla Palma, Padova (IT); Diego Marcuzzi, Padova (IT); Piergiorgio Sonato, Padova (IT); Pierluigi Zaccaria, Padova (IT)

(73) Assignee: CONSORZIO RFX, Padova (IT)

(21) Appl. No.: 14/405,138

(22) PCT Filed: May 31, 2013
(86) PCT No.: PCT/IB2013/054504

§ 371 Date: Dec. 2, 2014

(30) Foreign Application Priority Data
Jun. 7, 2012 (IT) PD2012A000186

(51) Int. Cl. B23P 19/04

(52) U.S. Cl. CPC B23P 19/04
USPC 29/505

(57) ABSTRACT

A method for making junctions between a first body (A) made of a first material includes a tube (A1) and a second body (B) made of a second material and having a hole (B1) for the insertion of the tube (A1). The method includes the threading (A3) of the tube (A1) for screwing in a corresponding threaded portion (B3) of the hole (B1) in the second body (B), the creation of a recess (B2) in the opening of the hole (B1) in the second body (B) and the creation of a ring (A5) at the end (A2) of the tube (A1), wherein the ring (A5) and the recess (B2) have such a shape and size that the ring (A5) is forced in the recess (B2) producing a plastic deformation and thus a seal through interference between the first and second body.

The subject of the present patent is a novel method or technique for leak tight junctions for VTTJ—Vacuum Tight Threaded Junctions), for making heterogeneous or homogeneous junctions between weldable or non-weldable materials, compatible with high vacuum conditions.

The work leading to this invention has received funding from the European Joint Undertaking for ITER and the Development of Fusion Energy under the grant agreement F4E-2011-CIRT313-PMS-14.CD.

### GOAL

The new technique has been developed in the framework of research on controlled thermo-nuclear fusion, with the goal of obtaining reliable vacuum tight junctions between copper and steel for components subjected to a high heat flux. The new technique is also usable in several other industrial applications to make junctions with materials that can even be different from steel and copper, can require or not require vacuum tightness and on components that can be subjected or not subjected to high heat fluxes.

### STATE OF THE ART

Several techniques are presently known for joining metallic materials, wherein said junctions can be of heterogeneous or homogeneous type. the expression “welding between metallic materials” designates a process by means of which the two materials to be welded are joined through the formation of atomic and/or molecular links, due to the action of heat and/or pressure.

Gas welding is known, which uses a combustible gas combined with a comburent, i.e. oxygen, to produce a flame that is the heat source necessary to melt the joining material.

Classical gas welding has limited applications, because the heat supply is relatively low, hence the weldable thickness is limited.

Are welding is also known, which uses the heat generated by an electric arc between an electrode and the piece to be welded to obtain melting. This technique is how ever usable only with some types of materials.

Resistance welding is also known, which uses the electrical resistance of the components to be welded to obtain the necessary heat, and wherein the junction is obtained by applying also a suitable pressure.

Friction welding is known, where the heat is generated through friction, obtained by mechanical rubbing between the surfaces of the components to be welded, for example deriving from the relative rotation of the components. The parts to be welded are then joined by applying a sufficient pressure to generate the link. This technique is however usable only with some types of materials, and depends on the metallurgical state of the materials to be welded.

Ultrasonic welding is known, where the surfaces to be welded are subjected to a normal static force and a tangential force oscillating with a given frequency.

Electron beam welding is known, which is a melting process to be carried out under vacuum conditions, generating a local melting of the materials by means of a beam of electrons that create a common lattice by transforming the kinetic energy of the electrons into thermal energy when they impact the materials.

This technique is very expensive, requires large equipment that cannot be transported and specialized personnel.

Other welding techniques are also known, like laser welding, plasma welding, explosion welding, friction stir welding.

Brazing or weld brazing techniques are also known, which do not require melting of the base material. In these processes, a metal having a melting temperature lower than that of the materials to be joined is melt and forced to flow so as to fill the capillaries of the surfaces to be joined. However, the junctions obtained in this way have limited mechanical strength and pose other drawbacks.

U.S. Pat. No. 3,388,931 relates to a welding between a holed plate and a tube including the use of two members suited to be interposed between the holed plate and the tube, and in particular a heat-shrinking plastic insert suited to be inserted in the hole, and a cylindrical ferrule, made of plastic or metal, suited to be inserted between the tube and the insert, and wherein the application of heat causes the insert to shrink and thus the tube to be engaged into the hole of the plate.

Patent U.S. Pat. No. 2,658,706 relates to a method for constraining a pipe projecting from a floor or a wall, wherein a cylindrical sleeve is used to loosely surround the pipe and a pair of clamping members surround the pipe and are tapered so that their smaller ends are inserted in said sleeve, and pressing said clamping members towards said sleeve makes them clamp the pipe and complete the fixing operation.

### ADVANTAGES WITH RESPECT TO THE STATE OF THE ART

The main advantages offered by the VTTJ technique with respect to known techniques like friction welding, electron beam welding and brazing are the following:
easy process and low cost
cold processing, i.e. at room temperature, with no risk of affecting the properties of the materials and consequently the behaviour of the junction as a consequence of localized overheating. In fact, localized overheating could cause:
a decrease in the yield and ultimate stress of the materials, due to annealing and/or recrystallization this can happen in particular with ductile and/or low melting point materials, like copper;
cracks due to fragile interphases: this can happen in particular with high-alloy materials, like stainless steels;
reliability of the junction not dependent on material quality as there are no metallurgical transformations in the junction area during processing, thanks to the fact that it is a completely cold process;
possibility to use a wide range of compositions and metallurgical states of the base materials, as there are no constraints due to the influence of these factors on the reliability of the junction. On the other hand, considerable constraints related to the composition and metallurgical state of the base materials are present when other techniques, like friction welding, electron beam welding and brazing, are used:
good compatibility with small dimensions;
good compatibility with possible successive operations, like electrodeposition and electron beam welding.

### POSSIBLE APPLICATIONS

In general, the VTTJ technique is suitable for making a wide range of heterogeneous and homogeneous junctions between weldable or non-weldable materials.

By way of example, the VTTJ technique could be used to make junctions on heat exchangers, hydraulic plants, boilers, heating systems, etc. in the manufacturing, chemical, food, pharmaceutical, oil industries, etc. and in power plants.

Some possible applications in the field of nuclear fusion are:
acceleration grids for neutral beam injectors; this is the application for which the technique as developed;
line components for neutral beam injectors, like neutralizers, residual ion dumps and calorimeters;
components for ion sources, like Faraday shields, back plates, etc.;
electron absorbers;
blanket modules for the toroidal chamber;
divertor modules.

### DESCRIPTION

The invention concerns a method or technique for making heterogeneous or homogeneous junctions between weldable or non-weldable materials. In particular, the junction is obtained between a first body comprising at least a tubular portion or tube and made of a first material, and a second body made of a second material and featuring a hole for the insertion of said tube of the first body.

Said first material, of which said first body is made, and said second material, of which said second body is made, can be the same or different materials, suited to be welded to each other or not.

The new technique includes the following phases:
making a thread on at least part of the external surface of said tube of the first body, so as to allow said tube to be screwed in a corresponding threaded part that is integral with the second body, or attached to it;
making at least one hole in said second body, so as to define a duct for the insertion of at least part of said tube;
making at least one cylindrical or conical annular seat or recess, diverging towards the inlet of the hole, in proximity to or at the level of the inlet of said hole in said second body:
providing, on said external surface of said tube of the first body, at least one conical ring converging towards the end of the tube itself, or in any case with taper different from the taper of said conical recess of the second body;
   and wherein said conical or cylindrical ring and said cylindrical or conical recess have such a shape and size that, when said tube of the first body is at least partially inserted into said hole in the second body, and said tube is screwed in said second body, said conical or cylindrical ring is forced in said cylindrical or conical recess, causing the plastic deformation of said ring and/or of said recess.

Hence, a seal through interference is obtained between said first body and said second body.

Here below, particular reference is made to the attached figures, which are provided by way of non-limiting examples.

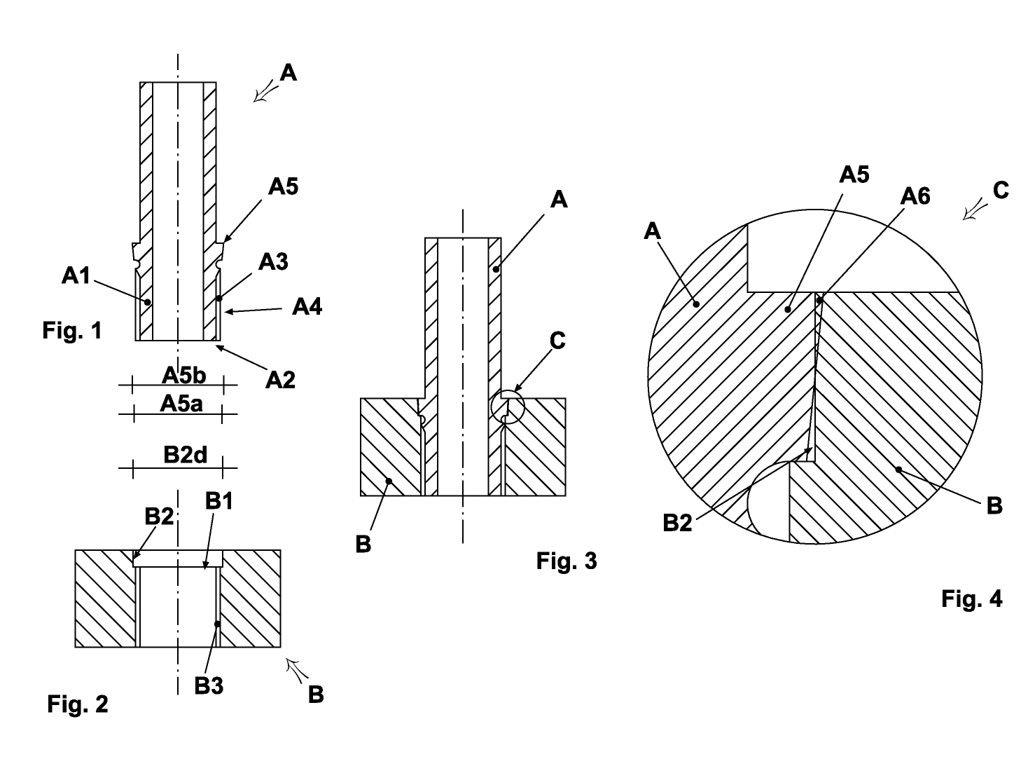

FIG. 1 shows a sectional view of the first body (A), in the shape of a tubular element or tube (A1).

FIG. 2 shows a sectional view of the second body (B), in the shape of a plate with a hole (B1) defining a duct for the insertion of part (A2) of said tube (A1).

FIG. 3 shows a sectional view of the first body (A) joined to the second body (B).

FIG. 4 shows a detailed sectional view of the junction area between said first body (A) and said second body (B) obtained through mechanical interference.

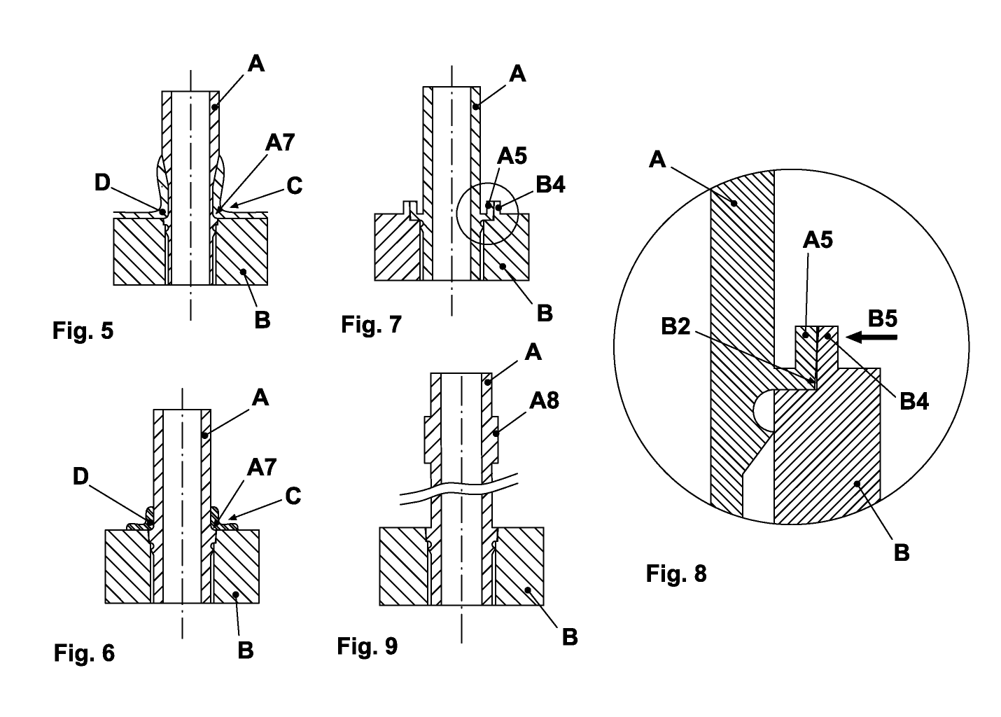

FIG. 5 shows a sectional view, according to a first embodiment, of the first body (A) joined to the second body (B) through electrodeposition (D).

FIG. 6 shows a sectional view, according to a second embodiment, of the first body (A) joined to the second body (B) through electrodeposition (D).

FIG. 7 shows a sectional niece of the first body (A) joined to the second body (B), wherein said first body (A) and said second body (B) are made according to an alternative solution, with a raised edge or rib (A5, B4) for the successive welding, illustrated in detail in FIG. 8.

FIG. 9 shows a schematic view of a section of the first body (A) with a portion (A8) with non-circular cross section suited to allow gripping by means of a screwing tool.

The new joining technique includes the steps described here below, for example to make a junction between a body (A), for example a tubular element or tube (A1) made of a first material, for example steel, and a body (B) made of a second material for example copper in the shape of a plate.

1. At least one hole (B1) is made in said copper plate (B), for example by milling, said hole being cylindrical or in any case defining a duct for the insertion of part of said tube (A1), in particular for the insertion of at least the end (A2) of said tube (A1).

2. The steel tube (A1) to be fixed to said copper plate or body (B) is at least partially threaded (A3) on its external surface (A4), for example in proximity to said end (A2) to be inserted in said hole (B1) of the plate or body (B).

3. The inside of said hole (B1) is preferably at least partially threaded (B3) at the level of said thread (A3) of said tube (A1).

4. At the inlet of said hole (B1) in the copper plate or body (B) there is at least one cylindrical recess (B2), while the steel tube (A1) is turned in order to obtain, in a given position along its external surface (A4), a conical ring (A5) converging towards the end (A2) of the tube (A1) itself. Said conical ring (A5), for example, is located at the beginning of said thread (A3), on the opposite side with respect to the end (A2) of the tube (A1).

Said conical ring (A5) and said cylindrical recess (B2) have such a shape and size that. once the tube (A1) has been screwed into the hole (B1) of the plate (B), said conical ring (A5) is forced in the cylindrical recess (B2), causing the plastic deformation of the plate (B) and/or of the tube (A), depending on the material of which they are made.

In this way, a seal through mechanical interference is also obtained between said tube (A1) and said plate (B).

In particular, the diameter (A5a) of the lower end of said conical ring (A5) is smaller than the diameter (B2d) of the cylindrical recess (B2), so as to allow for insertion, while the diameter (A5b) of the upper end is larger than the diameter (B2d) of the cylindrical recess (B2), so as to obtain the interference (A6).

In the preferred solution, said maximum diameter (A5b) of the conical ring (A5) is about 0.1-0.2 mm larger than the diameter (B2d) of the cylindrical recess (B2). The dimensions can however vary as a function of the geometry of the, unction and of the materials used.

5. The steel tube (A1) is screwed in the corresponding hole (B1) of the copper plate (B). During the screwing phase, in general approximately during the last turns, the plastic deformation of the cylindrical recess (B2) in the hole (B1) of the copper plate (B) takes place, and a seal is consequently obtained.

If the material of the first body (A) is softer than that of the second body (B), there will be a plastic deformation of the conical ring (A5), owing to which a seal will equally be obtained. If the materials of the first body (A) and of the second body (B) feature a similar degree of hardness or if said first body (A) and said second body (B) are made of the same material, the plastic deformation will take place both in said cylindrical recess (B2) and in said conical ring (A5) and analogously to the previous cases a seal will be obtained through plastic deformation.

### Tests Performed

Vacuum leak tests with a leak finder were carried out on several prototypes using helium as a sample gas. These tests showed that the junction made with the VTTJ technique haw no leaks. Analogous tests were successively performed after cyclic loading with an internal pressure of 30 bars repeated 10 times, showing again total absence of leaks. Finally, analogous tests were performed after a heat treatment lasting one hour at 200° C., showing also in this case total absence of leaks.

### Possible Subsequent Operations

The present technique can include further operations of electrodeposition, electron beam welding or brazing, to be executed after screwing the steel tube (A1) into the copper body (B), in order to make the junction compatible with use in particularly severe conditions, for example with high thermal and/or mechanical-structural loads.

For example, according to the invention, a strip (D) of a suitable material, for example a copper layer, can be electrodeposited along the junction edge (C) and on the surrounding area.

This further copper layer (D) that has been deposited has the main function to guarantee a vacuum tight seal also in the presence of particularly severe operating conditions, for example with high mechanical and/or thermal loads.

Moreover, before screwing said tube (A) into said copper body (B), a thin layer of copper can be electrodeposited on the steel tube, at the level of said conical ring (A5) and in proximity to its non-threaded portion, to improve adhesion for the following electrodeposition.

In order to better execute the electrodeposition of copper, the portion of the tube immediately above the conical ring can be connected to the ring itself with a fitting (A7) featuring a suitable radius.

As an alternative or as an addition to the above, each one of the joined edges of said tube (A1) and said copper body (B), i.e. said conical ring (A5) and said cylindrical recess (B2) are positioned on a raised edge or rib (A5, B4) to allow for the following electron beam welding.

In FIG. 8, the position where it is preferable to execute the electron beam welding is indicated by an arrow (B5).

According to the invention, said tube (A1) can at least partly (A8) feature a non-circular cross section, in such a way as to allow said tube (A1) to be gripped with suitable tools and screwed into said second body (B), wherein said portion (A8) with non-circular section is located at a certain distance from said conical ring (A5).

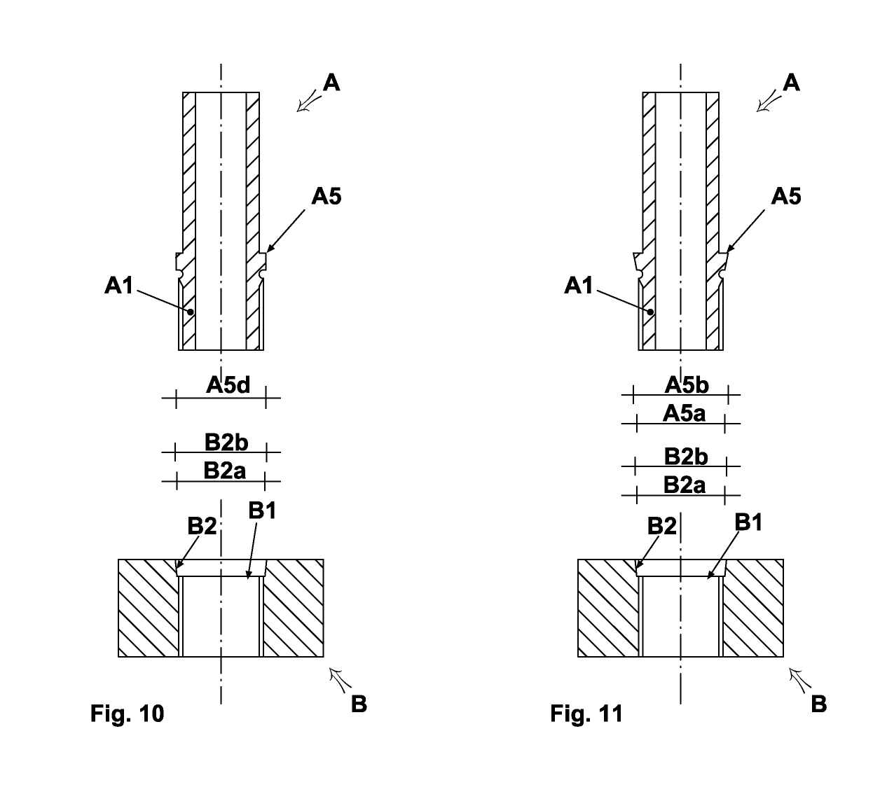

FIGS. 10 and 11 show two possible variant embodiments of the same innovative concepts.

According to an equivalent solution, a conical recess diverging towards the inlet of the hole (B1) is created in said hole (B1) in the second body (B), in addition to a cylindrical ring that is provided on said tube (A1) of the first body (A), so that once said tube (A1) of the first body (A) has been at least partially inserted in said hole (B1) in the second body (B) and said tube (A1) has been screwed in said second body (B), said cylindrical ring is forced in said conical recess, thus producing the plastic deformation and consequently obtaining a seal through interference between said first body and said second body.

In particular, as shown in FIG. 10, the diameter (B2b) of the inlet opening of said conical recess (B2) is larger than the diameter (A5d) of the cylindrical ring (A5), so as to allow for insertion, while the diameter (B2a) of the opposite end is smaller than the diameter (A5d) of the cylindrical ring (A5) so as to obtain the interference (A6).

According to a further equivalent solution, a conical recess diverging towards the inlet of the hole (B1) is created in said hole (B1) in the second body (B), in addition to a conical ring that is provided on said tube (A1) of the first body (A), wherein the taper of said conical ring of the first body (A) is different from the taper of the conical recess of the second body (B), so that the conical ring can be forced in the conical recess obtaining the interference.

As shown in FIG. 11, the diameter (A5a) of the lower end of said conical ring (A5) is smaller than the inlet diameter (B2b) of the conical recess, so as to allow for insertion, while the diameter (A5b) of the upper end is at least larger than said inlet diameter (B2d) of the conical recess (B2) so as to obtain the interference (A6).

Therefore, with reference to the above description and the attached drawings, the following claims are expressed.

1. A method or technique for making heterogeneous or homogeneous junctions between weldable or non-weldable materials in order to join:
a first body made of a first material and comprising at least one tubular portion or tube and
a second body made of a second material and comprising a hole for the insertion of at least one portion of said tube of the first body,
said first and said second material being made of the same or different materials, wherein it comprises the following steps:
making a thread on at least part of the external surface of said tube of the first body for screwing said tube in a corresponding threaded portion that is integral with or created in said second body;
making at least one annular seat or recess in proximity to or at the level of the inlet of said hole in said second body;
making at least one ring, whose walls have a convergence angle different from that of the walls of said recess, on said external surface of said tube of the first body,
and wherein said ring and said recess have such a shape and size that, once said tube of the first body has been at least partially inserted in said hole in the second body and said tube has been screwed in said second body, said ring is forced into said recess obtaining the plastic deformation of said ring and/or of said recess and thus a seal through interference between said first body and said second body.

2. The method or technique according to claim 1, wherein said recess is cylindrical and said ring is conical, converging towards the end of the tube, and wherein the diameter of the lower end of said conical ring is smaller than the diameter of the cylindrical recess so as to allow for insertion, while the diameter of the upper end is larger than the diameter of the cylindrical recess so as to obtain the interference.

3. The method or technique according to claim 1, wherein said recess is conical, diverging towards the inlet of the hole, and said ring is cylindrical, and wherein the diameter of the inlet opening of said conical recess is larger than the diameter of the cylindrical ring so as to allow for insertion, while the diameter of the opposite end is smaller than the diameter of the cylindrical ring so as to obtain the interference.

4. The method or technique according to claim 1, wherein said recess is conical, diverging towards the inlet of the hole, and said ring is conical, converging towards the end of the tube, and wherein the diameter of the lower end of said conical ring is smaller than the inlet diameter of the conical recess so as to allow for insertion, while the diameter of the upper end is larger than said inlet diameter of the conical recess so as to obtain the interference.

5. The method or technique according to claim 1, wherein said tube is threaded at least in proximity to its end suited to be inserted in said hole in the second body.

6. The method or technique according to claim 1, wherein said conical or cylindrical ring is created in proximity to said thread of said tube, on the side opposite said end of the tube.

7. The method or technique according to claim 1, wherein the inside of said hole in said second body is at least partially threaded at the level of said thread of said tube for screwing the tube in said hole.

8. The method or technique according to claim 1, wherein it comprises the further stages of electrodeposition and/or electron beam welding or brazing carried out after joining said tube to said second body.

9. The method or technique according to claim 1, wherein a strip or layer of copper or a suitable material is electrodeposited along the connection edge between said tube and said second body and in the immediately surrounding area, said strip or layer having the function of guaranteeing a vacuum seal also in conditions of mechanical stress and high thermal loads.

10. The method or technique according to claim 1, wherein it also comprises a preventive electrodeposition of material on said tube at the level of said conical or cylindrical ring and near it, on the non-threaded portion, in order to increase adhesion for the successive electrodeposition, said preventive electrodeposition being carried out before joining said first tube to said second body.

11. The method or technique according to claim 1, wherein each one of the joined edges of said tube and of said second body, that is, said conical or cylindrical ring and said cylindrical or conical recess, are made on a raised edge or rib to facilitate the successive welding between them.

12. The method or technique according to claim 1, wherein said first body is a tube and said second body is a plate-shaped body, on a surface of which there is said hole threaded inside and defining the insertion duct of said tube.

13. The method or technique according to claim 1, wherein said tube has at least partially a non-circular cross section, so as to ensure that it can be gripped with tools for screwing said tube in said second body.
